(19) United States
(12) Patent Application Publication
(10) Pub. No.: US 2007/0082739 A1
(43) Pub. Date: Apr. 12, 2007

(54) Game apparatus and game system

(75) Inventor: Keiji Tsubota, Saitama (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/545,537

(22) Filed: Oct. 11, 2006

(30) Foreign Application Priority Data
Oct. 11, 2005 (JP) 2005-296710

(51) Int. Cl. A63F 9/24; A63F 13/00

(52) U.S. Cl. 463/42; 463/43

(57) ABSTRACT

A game apparatus recognizes a user based on a user ID set to user by user, and issues a character card. To start a game, the user sets the character card in the game apparatus. After the game is ended, a save data representing a game result is associated with the user ID and stored in a server. At the start of the next game, the character card is set in the game apparatus and the save data is read from the server to the game apparatus based on the user ID, so that the game is continued from the previous game according to the save data.

### BACKGROUND OF THE INVENTION

1. Field of the Invention

The present invention relates to a game apparatus and a game system executing a game according to card information recorded on a character card.

2. Description of the Related Arts

A game apparatus using a character card, on which a character image such as a monster, an insect, a soccer player or a game item is printed, is widespread. The game apparatus detects a kind of the character card from a barcode or the like recorded on the character card, and features the character printed on the character card in the game. A game user (game player) has joy of collecting the character cards, in addition of playing the game with use of the character cards.

The character card is sold by automatic merchandising of the game apparatus, or sold at a store. However, since the character cards are usually packed in opaque bags, a buyer (user) never knows which character card he/she is going to buy. As a result, there is a problem that the user possibly obtains plural character cards of same kind. In addition, result of a game played with the character card cannot be saved, and the game cannot be continued from the previous game.

To solve these problems, the U.S. Pat. No. 6,468,162 discloses a game system in which a mobile information recorder (memory card) is used and a game apparatus sends/receives character information to/from the mobile information recorder set in the game apparatus. This game apparatus can make a character card by printing the character information recorded in the mobile information recorder. Since this game apparatus allows the user to select desired character information from which the character card is made, it is prevented that the user redundantly obtains the character cards of same kind. In addition, this game apparatus can save the game result in the mobile information recorder.

However, there is a problem in the game apparatus of the U.S. Pat. No. 6,468,162, that the user needs to bring the mobile information recorder together with the character card to play the game, and it is burdensome to the user.

### SUMMARY OF THE INVENTION

An object of the present invention is to provide a game apparatus and a game system in which a user can play a game with use of a character card and without use of a mobile information recorder.

In order to achieve the above and other objects, a game apparatus of the present invention uses a character card which records card information related to the character image printed thereon, and executes a game according to the card information. The game apparatus comprises a user ID setting section for setting a unique user ID to a user, and a communicating section to transmit save data associated with the user ID to a server. The save data represents a game result of the user.

It is preferable that the game apparatus further comprises a card issuing section for making the character card and issuing it to the user. The card issuing section includes a printer for printing the character image on a medium, and an information recorder for recording the card information on the medium. When the card information is recorded as a barcode, the printer records the card information on the medium.

It is preferable that the game apparatus further comprises a card issue controller for making card issue record which includes the kind of the character card issued by the card issuing section. The card issue record is associated with the user ID of the user to whom the character card is issued. The communicating section transmits the card issue record to the server. It is preferable that the card issue controller determines kinds of the character cards, which are available to the user, based on the card issue record.

It is preferable that the game apparatus further comprises a selector operated by the user to select one kind of the character cards to be issued, from the kinds of the character cards available to the user.

A game system of the present invention is composed of a game apparatus executing a game according to the card information recorded on the character card, and a server connected to the game apparatus through a communication network.

It is preferable that the game apparatus further includes a card issue controller for making card issue record which includes the kind of the character card issued by the card issuing section. The card issue record is associated with the user ID of the user to whom the character card is issued, and the server includes a card issue record memory for storing the card issue record. The card issue controller determines kinds of the character cards, which are available to the user, based on the card issue record.

It is preferable that the server further includes a card list memory for storing a list of all kinds of the character cards, and the card issue controller reads a list of the character cards available to the user from the card list memory. And it is preferable that the game apparatus further includes a selector operated by the user to select one kind of the character cards to be issued, from the list of the character cards available to the user.

According to the present invention, since the user IDs are set to user by user, the user can be identified by the user ID. And since the server connected to the game apparatus stores the game result associated with the user ID, the user can play the game continued from the previous game. In addition, the user can play the game using only the character card, so that the user is burden-free.

Since the card issuing section is provided for making the character card on which the character image is printed and the card information is recorded, the character card whose content is reflected by the game result can be issued. Accordingly, for example if the character changes its shape by the result of the game, the game apparatus can issue a new character card of the changed character according to the game result. In addition, the character card of a character newly appears during the game can be also issued. Therefore, the appeal of the game will be increased.

Since the card issue record of the character card is stored, the game company easily perceives the distribution state of the character cards. Since the kinds of the character card to be issued is determined according to the card issue record, or the user selects the favorite character card from the list of the character cards available to the user, it is prevented that the user obtains the character cards of same kind.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a configuration diagram of a game system of the present invention;

FIG. 2 is an explanatory view of an example of a character card;

FIG. 3 is an external view of a game apparatus of the present invention;

FIG. 4 is a block diagram of the game apparatus;

FIG. 5 is a flowchart of a game;

FIG. 6 is an explanatory view of an example of a confirmation screen; and

FIG. 7 is an explanatory view of an example of a guidance screen.

### DETAILED DESCRIPTION OF THE PREFERRED EMBODIMENTS

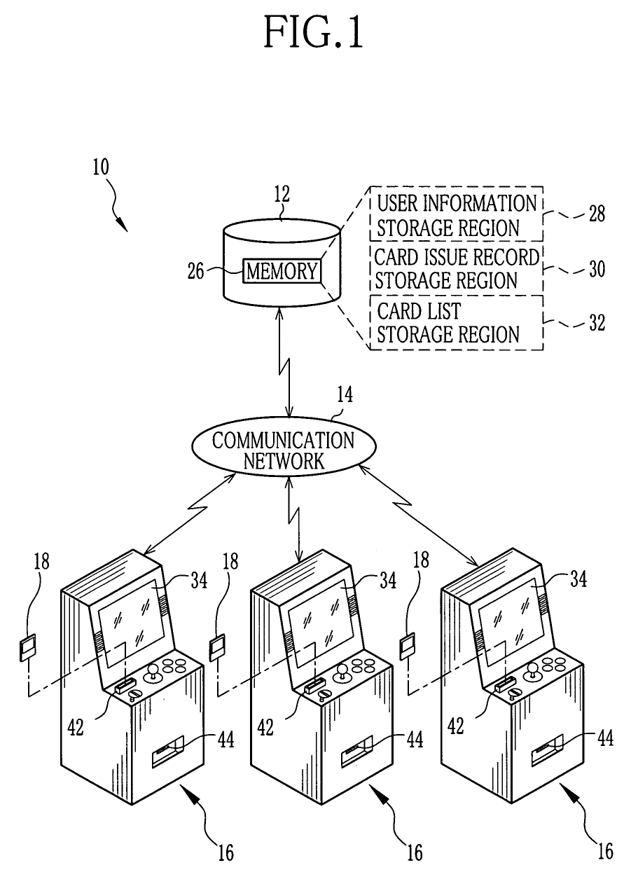

As shown in FIG. 1, a game system 10 is composed of a server 12 and a plurality of game apparatuses 16 connected to the server 12 through a known communication network 14. The game system 10 runs a game with use of a character card 18 issued by the game apparatus 16.

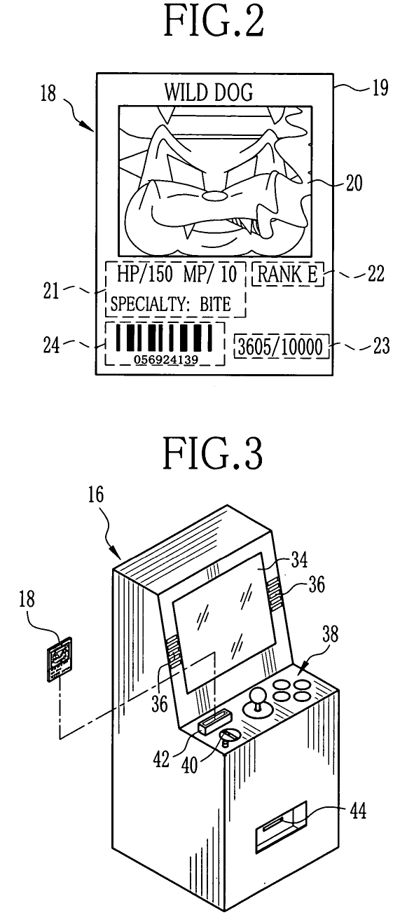

As shown in FIG. 2, the character card 18 is made such that a character image 20 of for example a monster or an item that will appear in the game, and card information related to the character card 18 are printed on a surface of a dedicated card-like medium 19. The card information includes character information 21 representing for example strength or specialty of the character, a card rank 22 representing an availability of the card, a card number 23 representing a card issued order within a maximum number of cards to be issued, and so on. In addition, on the surface of the medium 19, a barcode 24 is printed. The barcode 24 is encoded information which is optically readable and includes same contents as the printed card information.

In FIG. 1, the server 12 has a memory 26 which stores various information and functions as a database for all the game apparatuses 16. The memory 26 includes a user information storage region 28, a card issue record storage region 30, and a card list storage region 32.

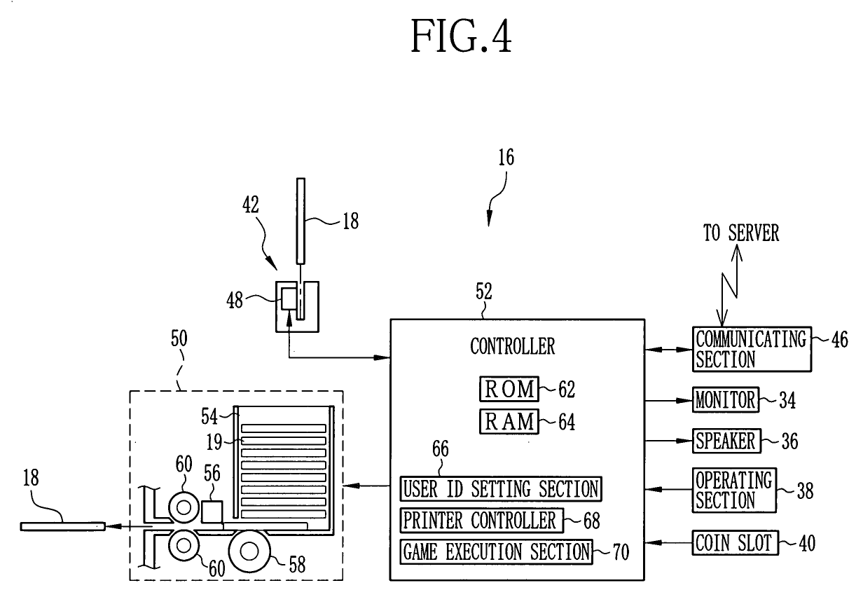

In the user information storage region 28, user IDs set separately to individual users by a user ID setting section 66 (see FIG. 4) are recorded. In addition, save data which includes a game result, a user rank and a character level determined by the game result is related to the user ID and recorded in the user information storage region 28. The save data is transmitted from the game apparatus 16 to the server 12 at the end of the game, to be recorded in the user information storage region 28. At the start of the game, the game apparatus 16 reads the save data from the user information storage region 28.

In the card issue record storage region 30, card issue records of the character cards 18 issued by each game apparatus 16 are stored. The card issue record includes a kind and an issue date and time of the character card 18 associated with the user ID. Every time the new character card 18 is issued, each game apparatus 16 sends the card issue record, which is then recorded in the card issue record storage region 30.

In the card list storage region 32, information of all kinds of the character cards 18 is stored according to the card rank. In addition, in the card list storage region 32, the maximum issue number for each kind of the character card 18 is recorded.

As shown in FIG. 3, the game apparatus 16 has a monitor 34 at front face thereof. The monitor 34 is a CRT or a liquid crystal panel, on which a game screen, an operation guide screen and so on are displayed. At both sides of the monitor 34, speakers 36 are provided for outputting sound effects in the game and so on. In front of the monitor 34, an operating section 38, a coin slot 40 and a card slot 42 are provided. Below them, a card issuing slot 44 is provided.

In the operating section 38, there are an operation lever and various operation buttons for operations. Coins are inserted into the coin slot 40, and the character card 18 is set to the card slot 42. From the card issuing slot 44, a newly issued character card 18 is ejected.

As shown in FIG. 4, in the game apparatus 16, a communicating section 46, a barcode reader 48, a printer 50 and a controller 52 are provided. The communicating section 46 is connected to the communication network 14 for exchange of the information between the game apparatus 16 and the server 12. The barcode reader 48 is provided inside the card slot 42, to read the card information from the barcode 24 printed on the character card 18 set in the card slot 42. The read card information is send to the controller 52.

As the printer 50, every known printer, such as an ink-jet printer, a laser printer, a thermal printer can be used. The printer 50 has a media container 54, a conveying mechanism and a printing head 56. In the media container 54, the media 19 without any prints are contained as a material of the character cards 18. The conveying mechanism is comprised of a drawing roller 58 for drawing the medium 19 one by one from the media container 54, a conveying roller pair 60 for conveying the medium 19 with holding the medium 19 from the front and back surfaces thereof and so on, and conveys the medium 19 from the media container 54 to the card issuing slot 44.

The printing head 56 prints the character image 20, the character information 21, the card rank 22, the card number 23 and the barcode 24 on the medium 19 while conveyance. Accordingly, the new character card 18 is made and issued (ejected) from the card issuing slot 44.

To the controller 52, the above-described sections of the game apparatus 16 are connected. The controller 52 reads control programs from a ROM 62 to a RAM 64 which is a working memory. According to the read control programs, the controller 52 controls operations of these sections. In addition, the ROM 62 stores other programs such as a game program for proceeding the game, and these programs are read to the RAM 64 when being executed.

In the controller 52, the user ID setting section 66 is provided. The user ID setting section 66 gives a user ID to a user when the user is new and the user ID is not assigned to the user yet. The user ID setting section 66 accesses the server 12 to refer to the user information storage region 28, and a user ID not registered is given to the new user. The new user ID is stored (registered) in the user information storage region 28. Since then, this user ID is used for recognizing this user.

Since the user IDs need only be different from each other, the user ID automatically registered by the user ID setting section 66 may be changed by the user later. In addition, it maybe possible that the user inputs a favorite user ID at first, and then this user ID is registered unless the same user ID has already been registered.

The controller 52 also includes a printer controller 68 and a game execution section 70. These sections perform various processing according to the user ID. The printer controller 68 controls the printer 50 to issue the character card 18.

Before issuing the character card 18 to the user, the printer controller 68 accesses the server 12 to refer to the user information storage region 28 for confirming a rank of this user and to refer to the card issue record storage region 30 for the kinds of the character cards 18 which are already issued to the user. Then the printer controller 68 accesses the card list storage region 32 to read information of the character cards 18 which has not been issued to the user yet and whose card ranks are no more than the maximum card rank determined according to the user rank.

The user selects a favorite character card 18 from these character cards 18. The printer controller 68 controls the printer 50 to issue the selected character card 18. In this time, the printer controller 68 accesses the server 12 to refer to the card issue record storage region 30 and the card list storage region 32, so as to examine the card issued order and the maximum issue number of the aforesaid character card 18. Then the card number 23 is printed on the aforesaid character card 18 by the printer 50.

After issuing the character card 18, the printer controller 68 makes a new card issue record which includes the kind and an issue date and time of the issued character card 18 associated with the user ID of the user to whom the card is issued. Then the printer controller 68 accesses the server 12 to record the card issue record in the card issue record storage region 30.

To the game execution section 70, the card information read by the barcode reader 48 is input. The game execution section 70 executes the game program according to the card information. At the start of the game, the game execution section 70 accesses the server 12 to refer to the user information storage region 28, and reads out the save data associated with the user ID. In the game, when the user beats an enemy character, a scenario proceeds and the user rank and the character level are raised. The game can be continued from the previous game according to the save data read by the game execution section 70.

At the end of the game, the game execution section 70 makes the save data which includes the game result, the user rank and the character level determined by the game result, associated with the user ID. Then the game execution section 70 accesses the server 12 to record the save data in the user information storage region 28.

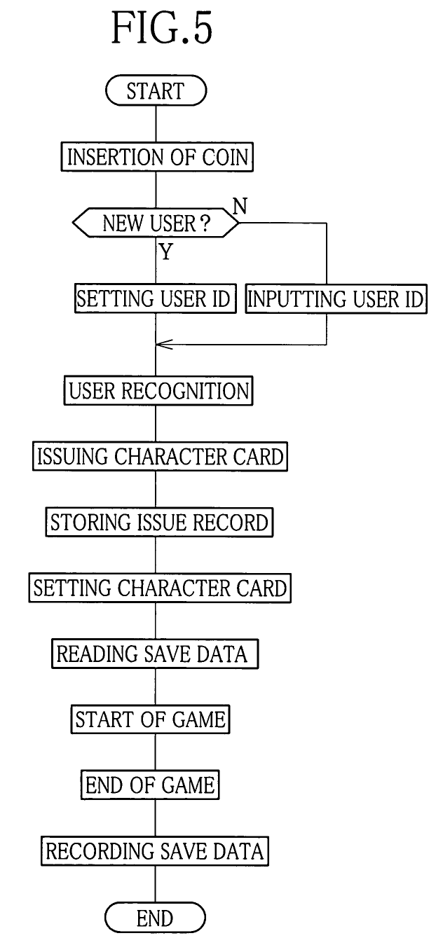

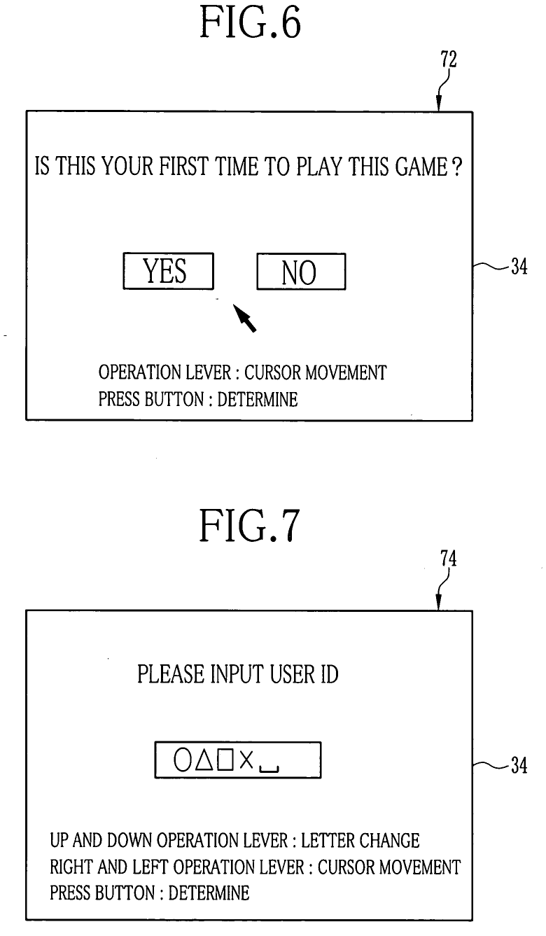

Hereinafter, the operations of the above-described embodiment of the present invention is described with reference to a flow chart shown in FIG. 5. When a coin as a game charge is entered into the coin slot 40, the controller 52 displays a confirmation screen 72 such as for example shown in FIG. 6, on the monitor 34 to confirm whether a player (user) is a new user or not. When “Yes” is selected on the confirmation screen 72, that means the player is a new user and a user ID has not been registered yet, the user ID setting section 66 sets a new user ID for this user. After that, the player (user) is identified by the user ID.

When “No” is selected on the confirmation screen 72, that means the user ID has already been set, the controller 52 displays a guide screen 74 such as for example shown in FIG. 7, on the monitor 34 to make the user input the user ID. When the user inputs the user ID by operating the operating section 38, the player (user) is identified by the input user ID. Note that it may be possible that the user inputs passwords in addition to the user ID for the identification.

After completing the identification (recognition) of the user, the character card 18 is issued. At this time, a list of the character cards 18, which has not been issued to the user yet and whose card ranks are no more than the maximum card rank determined according to the user rank, is displayed on the monitor 34. The user can select a favorite character card 18 from the list. The selected character card 18 is made and ejected (issued) from the card issuing slot 44. On the character card 18, the character image 20, the character information 21, the card rank 22, the card number 23 and the barcode 24 are printed. After the issue of the character card 18, the card issue record is recorded in the server 12.

After that, when the character card 18 is set to the card slot 42, the card information is read out from the barcode 24, and the game is executed according to the card information. At the start of the game, the save data associated with the user ID is read from the server 12, so that the game can be continued from the previous game according to the save data. At the end of the game, the save data associated with the user ID, which includes the game result, the user rank and the character level determined by the game result, is recorded in the server 12.

As described above, since the game result can be recorded in the server to continue the game from the previous game, the user enjoys proceeding the scenario of the game and increasing the user rank to obtain the character cards of higher card ranks. In addition, the user can avoid obtaining the character cards of same kind. Since the character card to obtain can be selected by the user, the user can collect favorite character cards. Since the card number is printed on the character card, the user can compete with other users for who obtains a certain character card first. Since the card issue record is stored in the server, the game company easily perceives the distribution state of the character cards.

In the above embodiment, the user selects the character card to be issued. However, the present invention is not limited to this. For example, the character card to be issued can be randomly selected from the character cards which have not been issued to the user yet.

In the above embodiment, the card information is printed in the form of the barcode. However, it may be possible that the medium for the character card is an IC card having an IC chip, and the card information is electrically recorded in the IC chip. In addition, it may be that the medium is a magnetic card and the card information is magnetically recorded. In these cases, a dedicated reader for reading the card information from the IC card or the magnetic card is provided instead of the barcode reader, and a dedicated recorder for recording the card information electrically or magnetically is provided instead of the printing head.

In addition, the respective functions of the game apparatus and the server are not limited to the above embodiment. For example, the user ID setting section and the printer controller can be provided in the server. Further, when the game apparatus has the functions performed by the server in the above embodiment, the server can be omitted.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A game apparatus using a character card on which card information related to a printed character image is recorded, and executing a game according to said card information, said game apparatus comprising:
a user ID setting section for setting a unique user ID to a user; and
a communicating section to transmit save data associated with said user ID to a server, said save data representing a game result of said user.

2. A game apparatus claimed in claim 1, further comprising:
a card issuing section for making said character card and issuing it to said user, said card issuing section including a printer for printing said character image on a card-like medium, and an information recorder for recording said card information on said medium.

3. A game apparatus claimed in claim 2, wherein said information recorder is said printer, and said card information is recorded on said medium in form of a barcode.

4. A game apparatus claimed in claim 2, further comprising;
a card issue controller for making card issue record which includes a kind of said character card issued by said card issuing section, said card issue record being associated with said user ID, said card issue record being send by said communicating section to said server.

5. A game apparatus claimed in claim 4, wherein said card issue controller determines kinds of said character cards available to said user based on said card issue record.

6. A game apparatus claimed in claim 2, further comprising:
a selector operated by said user to select one kind of said character cards available to said user.

7. A game system comprised of a game apparatus using a character card on which card information related to a printed character image is recorded and executing a game according to said card information, and a server connected to said game apparatus through a communication network, said game system including:
A. said game apparatus including:
a user ID setting section for setting a unique user ID to a user; and
B. said server including:
a save data memory for storing save data made by said game apparatus, said save data representing a game result of said user and associated with said user ID.

8. A game system claimed in claim 7, wherein said game apparatus further including;
a card issuing section for making said character card and issuing it to said user, said card issuing section including a printer for printing said character image on a card-like medium, and an information recorder for recording said card information on said medium.

9. A game system claimed in claim 8, wherein said information recorder is said printer, and said card information is recorded on said medium in form of a barcode.

10. A game system claimed in claim 8, wherein said game apparatus further includes a card issue controller for making card issue record which includes a kind of said character card issued by said card issuing section, said card issue record being associated with said user ID, and wherein said server includes a card issue record memory for storing said card issue record.

11. A game system claimed in claim 10, wherein said card issue controller determines kinds of said character cards available to said user based on said card issue record.

12. A game system claimed in claim 8, further including:
A. said server further including:
a card list memory for storing a list of all kinds of said character cards, said card issue controller reading a list of said character cards available to said user from said card list memory;
B. said game apparatus further including:
a selector operated by said user to select one kind of said character cards to be issued, from said list of said character cards available to said user.
